(19) United States
(12) Patent Application Publication
(10) Pub. No.: US 2025/0305676 A1
(43) Pub. Date: Oct. 2, 2025

(54) BOILER DEVICE AND ORGANIC WASTE TREATMENT DEVICE PROVIDED WITH SAME

(71) Applicant: SHIMOSE MICROBES LABORATORY CORPORATION, Shimonoseki-shi (JP)

(72) Inventor: Shinichi SHIMOSE, Shimonoseki-shi (JP)

(21) Appl. No.: 19/234,440

(22) Filed: Jun. 11, 2025

Related U.S. Application Data
(63) Continuation of application No. PCT/JP2023/034829, filed on Sep. 26, 2023.

(30) Foreign Application Priority Data
Dec. 27, 2022 (JP) 2022-209281

(51) Int. Cl. F23G 5/04; B09B 3/40; B09B 3/60; F23B 30/00; F23B 40/06; F23G 5/44; F23G 5/46; F23J 1/06; F23K 1/00; F23K 3/22

(52) U.S. Cl. CPC F23G 5/04; B09B 3/40; B09B 3/60; F23B 7/002; F23B 40/06; F23G 5/444; F23G 5/46; F23J 1/06; F23K 1/00; F23K 3/22; F23G 2201/101; F23K 2201/20

(57) ABSTRACT

A boiler 7 includes: a combustion furnace 100 having a combustion chamber 100F therein; a heat exchanger 140 configured to transfer, to water, thermal energy obtained by burning a solid fuel in the combustion chamber 100F; a belt conveyor 120 including a movable loader 120a, disposed on a bottom of the combustion chamber 100F, and configured to move the solid fuel on the movable loader 120a in the combustion chamber 100F; and a fuel supplier 130 connected to a fuel supply port 111a that communicates an inside and an outside of the combustion furnace 100. The belt conveyor 120 has a starting point below the fuel supply port 111alb . The fuel supplier 130 includes a thickness adjuster 131 that adjusts a thickness of the solid fuel on the movable loader 120a of the belt conveyor 120.

### TECHNICAL FIELD

The present invention relates to an energy saving boiler and an organic waste processor including the boiler.

### BACKGROUND ART

Boilers have been considered which have a combustion efficiency increased to hardly cause unburned matters when burning organic wastes and other fuels (e.g., see Patent Document 1).

The boiler according to Patent Document 1 includes a burner as combustion equipment that burns a supplied fuel in combustion chambers, a combustion furnace having a combustion chamber therein, and a heat exchanger configured to transfer, to water, thermal energy obtained by burning the fuel using the burner. The burner is directly connected to a side wall of the combustion furnace so as to oppose the combustion chambers of the burner to the combustion chamber of the combustion furnace. The burner includes a primary combustion chamber for primary combustion of the supplied fuel and a secondary combustion chamber for secondary combustion of the fuel obtained by the primary combustion in the primary combustion chamber. The flame of the burner spreads from an opening of the side wall of the combustion furnace into the combustion furnace. The fuel is subjected to the secondary combustion in the burner before causing the flame in the combustion chamber of the combustion furnace, which hardly causes ash.

### CITATION LIST

### Patent Document

Patent Document 1: Japanese Unexamined Patent Publication No. 2020-193742

### SUMMARY OF THE INVENTION

### Technical Problems

In the boiler according to Patent Document 1, however, a solid fuel is not directly introduced into the combustion chamber of the combustion furnace, but is supplied through a fuel supply passage in the burner to the primary combustion chamber of the burner. Only the flame of the burner spreads in the combustion chamber of the combustion furnace. This flame of the burner spreads from an opening at one point of the side wall of the combustion furnace into the combustion chamber. It is thus difficult to directly apply the flame to a steam drum above the combustion chamber and the tops of a large number of water pipes in the combustion chamber.

In addition, the flame spreads from the opening described above as a starting point. It is thus difficult to heat the steam drum extending in the horizontal direction and the large number of water pipes connected to the steam drum over a wide area by means of strong heating power.

In the boiler according to Patent Document 1, the flame generated by supplying the fuel to the burner and performing the secondary combustion using the burner spreads in the combustion chamber of the combustion furnace. It is not easy to adjust the point and the magnitude of the flame in the combustion chamber of the combustion furnace. Accordingly, adjustment of the vapor output is difficult. The vapor output cannot thus accord to the variation of the amount of vapor to be used in the equipment, such as the vapor generator utilizing the vapor of the boiler, and the boiler consumes excessive energy.

The present invention was made in view of the above circumstances. It is an object of the present invention to provide a boiler capable of easily adjusting the vapor output in accordance with the amount of vapor to be used in equipment utilizing the vapor of the boiler and capable of saving the energy, and an organic waste processor including the boiler.

### Solution to the Problems

In order to achieve the object, the present invention disclosed in this specification is configured as follows. Specifically, a first aspect of the present invention is directed to a boiler including: a combustion furnace having a combustion chamber therein; a heat exchanger configured to transfer, to water, thermal energy obtained by burning a solid fuel in the combustion chamber; a belt conveyor including a movable loader, disposed on a bottom of the combustion chamber, and configured to move the solid fuel on the movable loader in the combustion chamber; and a fuel supplier connected to a fuel supply port that communicates an inside and an outside of the combustion furnace. The belt conveyor has a starting point below the fuel supply port. The fuel supplier includes a thickness adjuster that adjusts a thickness of the solid fuel on the movable loader of the belt conveyor.

According to the first aspect of the present invention, the solid fuel can be directly put into the combustion furnace through the fuel supply port, and can be moved by the belt conveyor to an appropriate point in the combustion chamber where thermal energy is easily transmitted to the water of the heat exchanger. The solid fuel is gasified and ignited in the combustion chamber, which can cause a flame on the movable loader of the belt conveyor. In addition, the thickness of the solid fuel on the movable loader of the belt conveyor is adjusted by the thickness adjuster of the fuel supplier, which can adjust the amount of the solid fuel to be gasified. Accordingly, unlike the typical boiler using a burner, the flame can spread largely in the horizontal direction and the vertical direction in the combustion chamber and the heat exchanger can thus be heated with strong heating power over a wide area.

Since the location and area of the solid fuel in the combustion chamber and the amount of the solid fuel can be adjusted easily by adjusting the speed of the belt conveyor and the thickness using the thickness adjuster, the amount of thermal energy to be transferred to the water in the heat exchanger can be adjusted easily. Accordingly, the output of the vapor to be generated by the heat exchanger can be adjusted easily. The vapor output can thus accord to even a variation in the amount of vapor to be used in equipment, such as the vapor generator utilizing the vapor of the boiler. As a result, an energy-saving boiler can be provided.

A second aspect of the present invention is an embodiment of the first aspect. In the second aspect, the thickness adjuster of the fuel supplier includes a gate movable vertically so as to change a vertical distance from the movable loader of the belt conveyor, and a driver configured to move the gate vertically.

According to the second aspect of the invention, the thickness of the solid fuel to be placed on the movable loader of the belt conveyor can be adjusted easily with a simple configuration. This can easily adjust the output by changing the thickness in accordance with the characteristics of the solid fuel to be used, and easily shut off the fuel supply by moving a gate in an emergency so as to eliminate the gap between the lower end of the gate and the movable loader.

A third aspect of the present invention is an embodiment of the first or second aspect. In the third aspect, the heat exchanger includes: a steam drum disposed above the combustion furnace, having a horizontal direction as a longitudinal direction thereof, and having a bottom exposed to the combustion chamber; a water drum below the steam drum in the combustion furnace; and water pipes each having one end connected to the steam drum and the other end connected to the water drum. The belt conveyor is disposed with a moving direction of the movable loader matching the longitudinal direction of the steam drum.

According to the third aspect of the present invention, the bottom of the steam drum is exposed to the combustion chamber. The moving direction of the movable loader of the belt conveyor matches the longitudinal direction of the steam drum. The solid fuel on the movable loader of the belt conveyor can thus be located right below the part of the steam drum exposed to the combustion chamber over a wide area. Accordingly, the hot air of the flame generated by gasifying and igniting the solid fuel can be widely and directly applied to the steam drum. This can thus efficiently transmit the thermal energy to the heat exchanger including the steam drum, and accelerate the reaction of vapor output generation from the start of driving of the boiler.

A fourth aspect of the present invention is an embodiment of the third aspect. In the fourth aspect, at least some of the water pipes extend in the vertical direction in the combustion chamber. The combustion furnace includes the fuel supply port in a wall at one end of the steam drum in the longitudinal direction and a gas discharge port in a wall at the other end of the steam drum in the longitudinal direction. The combustion furnace further includes a plurality of partition walls at predetermined intervals in the longitudinal direction of the steam drum so as to partition the combustion chamber. Each of the plurality of partition walls includes an opening for brining exhaust gas into contact with the water pipe in the combustion chamber, while allowing the exhaust gas to meander from the one end toward the other end of the steam drum.

According to the fourth aspect of the present invention, the combustion chamber is divided into a plurality of sections by the partition walls having the respective openings, and the exhaust gas comes into contact with the water pipes while meandering in the combustion chamber. This can increase the period of time when the exhaust gas remains in the combustion chamber and apply the flame and the exhaust gas to the water pipes efficiently. Accordingly, the thermal energy can be efficiently transferred to the heat exchanger including the water pipes.

A fifth aspect of the present invention is an embodiment of any one of the first to fourth aspects of the present invention. In the fifth aspect, the combustion furnace has a wall having a combustion air inlet for introducing combustion air from the outside into the combustion chamber at a height below the movable loader of the belt conveyor. A forced draft fan is connected to the combustion air inlet via an air intake duct.

According to the fifth aspect of the present invention, the combustion air sent from below the movable loader of the belt conveyor is sent upward from below the solid fuel on the movable loader, which can promote the gasification of the solid fuel and spread, upward from the movable loader, the flame generated by igniting the gasified gas. Accordingly, the thermal energy can be efficiently transferred to the heat exchanger over a wide area.

A sixth aspect of the present invention is an embodiment of any one of the first to fifth aspects. In the sixth aspect, the combustion furnace has a wall having a plurality of air inflow dampers for adjusting an amount of air to be introduced near the belt conveyor, in the moving direction of the movable loader of the belt conveyor.

According to the sixth aspect of the present invention, when the solid fuel on the movable loader spreads in the moving direction of the movable loader as the belt conveyor is driven, the amount of the solid fuel to be gasified and ignited at each point of the belt conveyor can be adjusted by adjusting the amount of the air to be introduced by each air inflow damper. Accordingly, the magnitude and point of the flame generated on the movable loader can be adjusted easily. The output of the vapor to be generated in the heat exchanger can thus be adjusted easily. In an emergency, the solid fuel can remain unburned and is heated by setting the opening degrees of all the air inflow dampers to zero.

A seventh aspect of the invention is an embodiment of any one of the first to sixth aspects. In the seventh aspect, an ash discharge conveyor for discharging ash of the solid fuel remaining on the movable loader to the outside of the combustion furnace is connected to a wall of the combustion furnace, below a terminal of the belt conveyor.

According to the seventh aspect of the present invention, even if the ash obtained by igniting and burning the solid fuel on the movable loader is continuously moved to the terminal of the belt conveyor by continuously driving the belt conveyor, the ash can be discharged outside the combustion furnace by the ash discharge conveyor. Accordingly, the movable loader of the belt conveyor is not completely buried in the ash. The solid fuel on the movable loader can thus be efficiently burned at all times.

An eighth aspect of the present invention is directed to an organic waste processor including the boiler of any one of the first to seventh aspects; and a fermentation dryer containing a processing target containing an organic waste in a sealed container, and configured to stir the processing target, while heating the processing target to a predetermined temperature range under a reduced pressure, and ferments an organic matter using microorganisms to decompose an odorous component and obtain a dried matter with a reduced volume. The dried matter provided by the fermentation dryer is supplied as the solid fuel to the combustion chamber of the combustion furnace of the boiler.

The eighth aspect of the present invention can burn and incinerate, in the boiler, the dried matter provided by the fermentation dryer and can thus eliminate the need to process the waste of the dried matter. In addition, the dried matter can be incinerated efficiently and immediately.

### Advantages of the Invention

The boiler according to the present invention can easily adjust the vapor output in accordance with the amount of vapor to be used in the equipment utilizing the vapor of the boiler.

The organic waste processor according to the present invention can burn and incinerate, in the boiler, the dried matter provided by the fermentation dryer and can thus eliminate the need to process the waste of the dried matter. In addition, the dried matter can be incinerated efficiently and immediately.

### BRIEF DESCRIPTION OF THE DRAWINGS

FIG. 1 is a block diagram showing an overall configuration of an organic waste processor including a boiler according to an embodiment of the present invention.

FIG. 2 is a schematic view showing an overall schematic configuration of a fermentation dryer included in the processor.

FIG. 3 is a sectional side view showing an overall schematic configuration of the boiler according to the embodiment of the present invention.

FIG. 4 is a cross-sectional view taken along line B-B and line C-C-D-D-E-E in FIG. 3.

FIG. 5 is a cross-sectional view taken along line A-A in FIG. 3.

FIG. 6 is a plan view showing an overall schematic configuration of a heat exchanger included in the boiler.

FIG. 7 is a block diagram showing a configuration for controlling the vapor output from the boiler.

### DESCRIPTION OF EMBODIMENT

An embodiment of the present invention will be described with reference to the drawings.

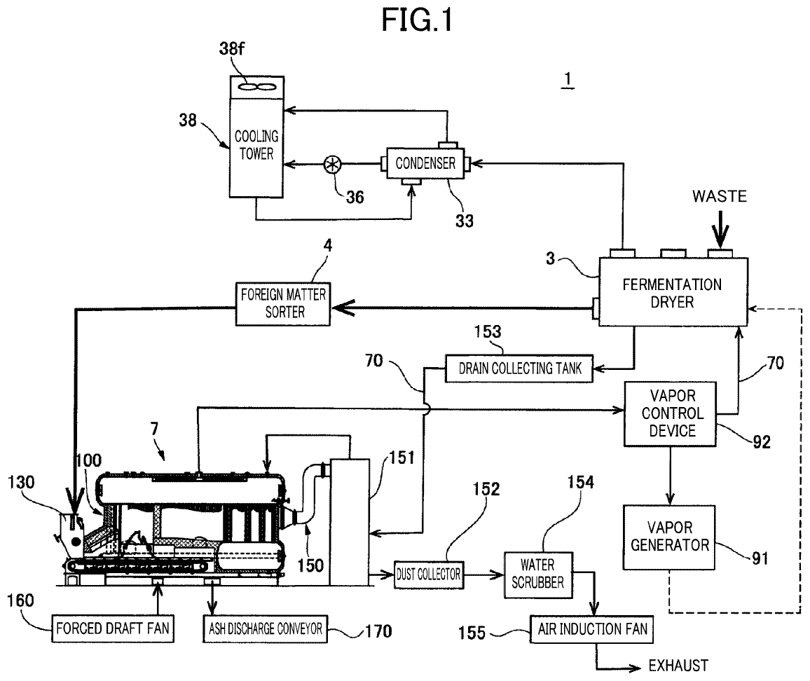

FIG. 1 shows an organic waste processor 1 according to an embodiment of the present invention. This processor 1 includes a fermentation dryer 3, a foreign matter sorter 4, a boiler 7, and a vapor generator 91. The fermentation dryer 3 treats, as processing targets, the organic food wastes discharged from general households and the organic wastes discharged from various offices. The fermentation dryer 3 performs a process of drying such organic wastes, while fermenting the organic wastes under a reduced pressure (hereinafter also referred to as a “reduced-pressure fermentation drying process”). The dried matter obtained by this reduced-pressure fermentation drying is sent to the foreign matter sorter 4 which then removes the foreign matter, such as metal, mixed in the dried matter. The dried matter after removing the foreign matter is supplied as a solid fuel to the boiler 7 and burned. By means of the combustion energy generated by burning the solid fuel, the vapor generator 91 generates the electric power part of which is used for the operation of the fermentation dryer 3. The thick solid line indicates the flow of the organic waste and the solid fuel. The solid line indicates the flow of the vapor and drain water. The broken line indicates the flow of the electricity generated by the vapor generator 91.

### Fermentation Dryer

The fermentation dryer 3 is known equipment described in Patent Document 1, for example. As will be described below, the fermentation dryer 3 stirs the organic waste to be processed, while heating the organic waste to a predetermined temperature range under a reduced pressure. In addition, the fermentation dryer 3 ferments the organic matter by means of microorganisms and decomposes an odorous component to obtain a dried matter of a reduced volume.

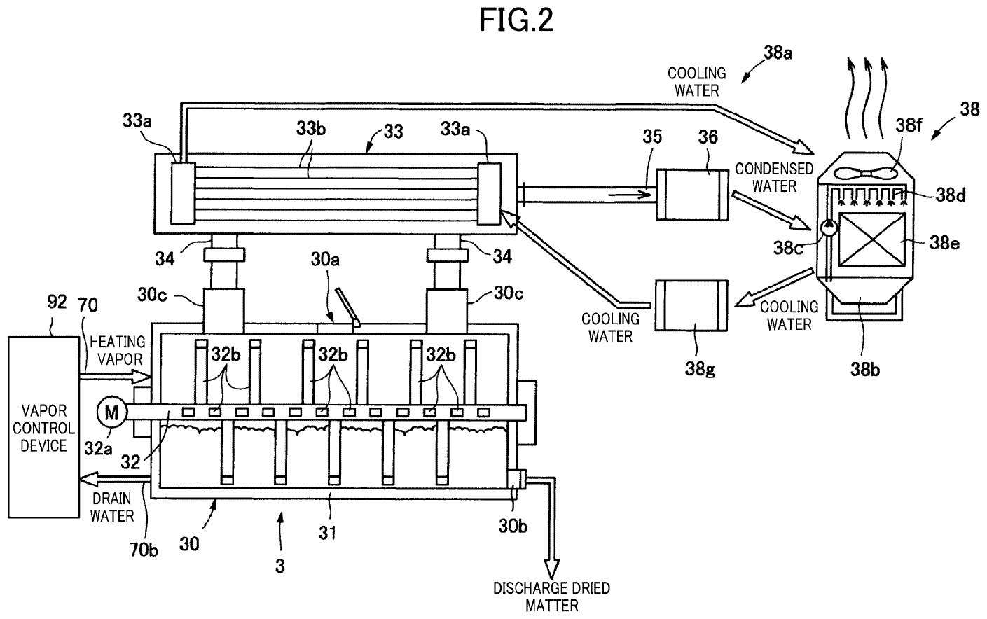

As schematically shown in FIG. 2, the fermentation dryer 3 includes a tubular tank 30. This tank 30 is a sealed container for containing an organic waste and airtight to maintain the inside at atmospheric pressure or lower. This tank 30 includes a heating jacket 31 on the circumferential wall thereof. The heating jacket 31 is supplied with heating vapor from the boiler 7 via a vapor control device 92.

The tank 30 includes, therein, a stirring shaft 32 extending in the longitudinal direction of the tank 30 (i.e., the horizontal direction in FIG. 2) so as to be surrounded by the heating jacket 31. The stirring shaft 32 is rotated at a predetermined rotation speed by an electric motor 32a. This stirring shaft 32 includes a plurality of stirring plates 32b spaced apart from each other in the axial direction thereof. The plurality of stirring plates 32b can stir wastes and send the stirred wastes in the longitudinal direction of the tank 30 after the end of the fermentation and drying. Note that the electric motor 32a may be replaced with a hydraulic motor.

Specifically, the tank 30 has a waste inlet 30a at the top of a central portion (i.e., a central portion in FIG. 2) in the longitudinal direction. The waste put into the inlet 30a is stirred by the rotating stirring shaft 32 as described above, while being heated by the heating jacket 31. After the elapse of a predetermined time, the stirred waste is discharged from an outlet 30b at the bottom of the tank 30.

Although not shown in detail, a vapor passage is also provided inside the stirring shaft 32 in this embodiment. This passage is also supplied with the heating vapor from the vapor control device 92 through a vapor passage 70. In this manner, the waste can also be heated inside the tank 30, while being stirred by the stirring shaft 32. The drain water obtained by condensing the vapor returns to the vapor control device 92 via a drain passage 70b.

As the microorganisms to be added to the organic waste in the tank 30, a composite effective microorganisms group obtained by culturing a plurality of kinds of indigenous bacteria as a base in advance is preferable, and what is called “SHIMOSE 1/2/3 group” is the center of the colony.

SHIMOSE 1 is FERM BP-7504 (deposited internationally on Mar. 14, 2003 in International Patent Organism Depository, National Institute of Bioscience and Human-Technology, National Institute of Advanced Industrial Science and Technology, Ministry of Economic and Industrial Science and Technology, 1-3, Higashi 1-chome, Tsukuba, Ibaraki, Japan). SHIMOSE 2 is FERM BP-7505 (deposited internationally in the same manner as SHIMOSE 1), which is salt-tolerance microorganisms belonging to the genus Pichiafarinosa. SHIMOSE 3 is FERM BP-7506 (deposited internationally in the same manner as SHIMOSE 1), which is microorganisms belonging to the genus Staphylococcus.

Guides 30c for guiding the vapor generated from the heated waste to a condenser 33 projects from the top of the tank 30 for heating the waste. These guides 30c are provided at respective ends of the tank 30 in the longitudinal direction. The condenser 33 includes a plurality of cooling tubes 33b supported by a pair of heads 33a. A cooling water passage 38a is provided between these cooling tubes 33b and a cooling tower 38 which will be described later.

Specifically, the cooling tower 38 includes a water tank 38b into which the cooling water discharged from the condenser 33 flows, a drawing pump 38c that draws up the cooling water from this water tank 38b, and a nozzle 38d that injects the drawn cooling water. The cooling water injected from the nozzle 38d receives the air from a fan 38f, while flowing down a downflow section 38e, which lowers the temperature of the cooling water. The cooling water flows down through the downflow section 38e, and then flows into the water tank 38b again.

The cooling water cooled by the cooling tower 38 in this manner is sent by a cooling water pump 38g and back to the condenser 33 through the cooling water passage 38a. The cooling water sent back to the condenser 33 increases in temperature by exchanging heat with the vapor generated from the waste as described above, while circulating through the cooling tubes 33b. The cooling water with the increased temperature flows through the cooling water passage 38a into the cooling tower 38 again. That is, the cooling water circulates through the cooling water passage 38a between the condenser 33 and the cooling tower 38.

The vapor generated from the heated waste is condensed by the condenser 33. In the cooling tower 38, however, the condensed water obtained by the condenser 33 also flows together with the cooling water circulating as described above. That is, the condensed water generated in the condenser 33 stays in the condenser 33 and a communication passage 35. In this embodiment, a vacuum pump 36 is connected to the condenser 33 through a communication passage 35 so as to reduce the pressure in the tank 30.

Once operating, the vacuum pump 36 sucks the air and the condensed water out of the condenser 33 through the communication passage 35 and guides the air and the vapor in the tank 30 to the condenser 33 through the guides 30c and a communication passage 34. In this manner, the condensed water is sucked out of the condenser 33 by the vacuum pump 36 and is guided by the water guide pipe from this vacuum pump 36 to the water tank 38b of the cooling tower 38.

The condensed water guided to the water tank 38b of the cooling tower 38 in this manner is mixed with the cooling water, drawn up by the drawing pump 38c, injected by the nozzle 38d, and then cooled, while flowing down the downflow section 38e. The condensed water contains the same microorganisms as those added to the waste in the tank 30, and odorous components or other harmful components contained in the condensed water are decomposed by the microorganisms. Accordingly, the odor contained in the condensed water is not emitted outside.

### Foreign Matter Sorter

The foreign matter sorter 4 includes a magnetic separator and a vibrating conveyor, and is provided to remove metal, such as metal fittings and iron pieces, mixed in the dried matter. The dried matter after removing the metal is, as a solid fuel, sent to a fuel supplier 130 of the boiler 7.

### Boiler

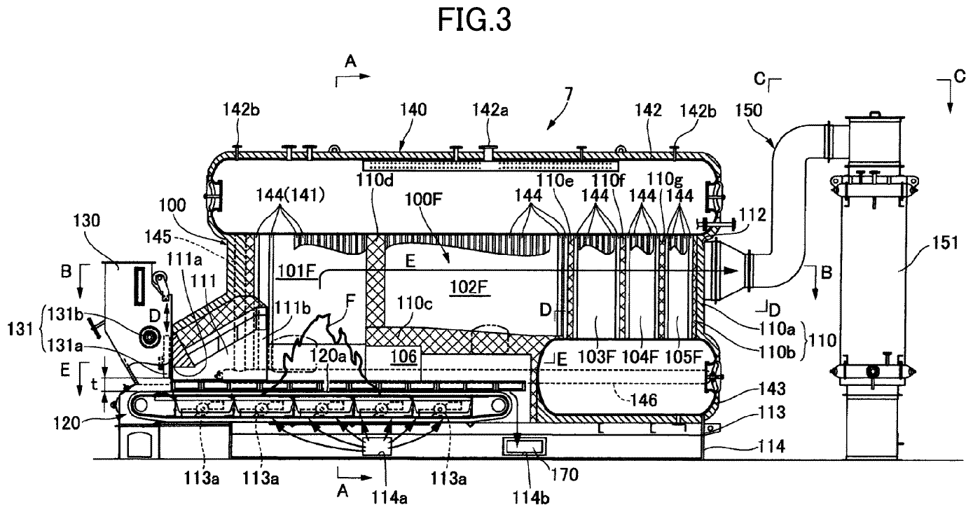

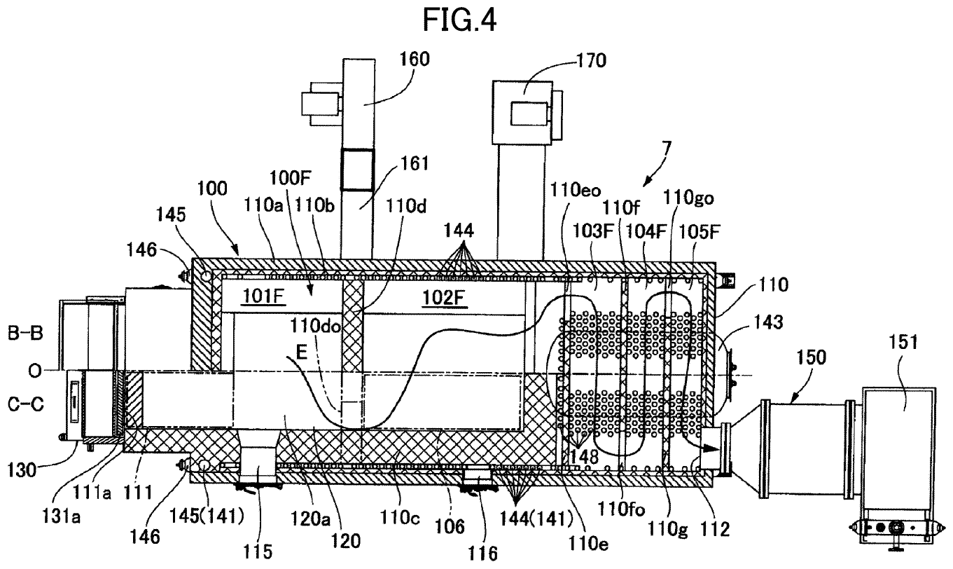

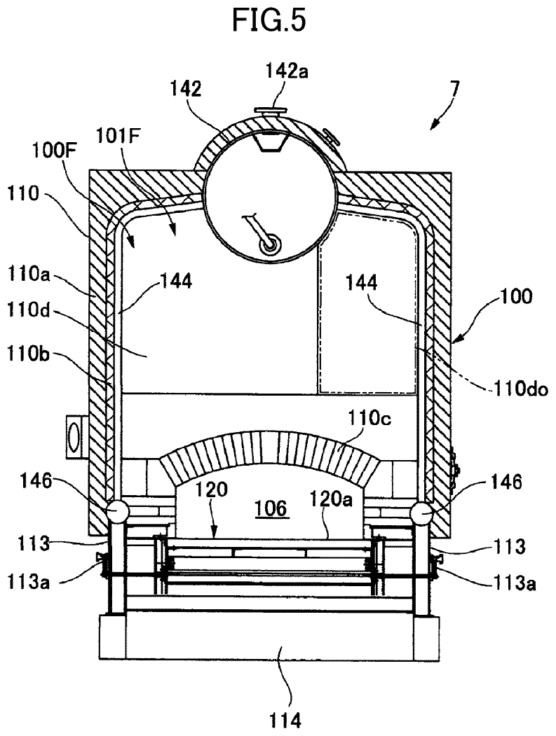

FIG. 3 is a sectional side view showing an overall schematic configuration of the boiler 7 according to this embodiment. FIG. 4 is a cross-sectional view taken along line B-B and line C-C-D-D-E-E in FIG. 3. FIG. 5 is a cross-sectional view taken along line A-A in FIG. 3. As shown in FIGS. 3 to 5, the boiler 7 includes a combustion furnace 100, a heat exchanger 140, a belt conveyor 120, and the fuel supplier 130. The combustion furnace 100 has a combustion chamber 100F therein.

### Combustion Furnace

The combustion furnace 100 has a wall 110 surrounding the combustion chamber 100F in the horizontal direction. The wall 110 includes an outer circumferential wall 110a and an inner circumferential wall 110b, which are made of metal such as steel. The inner circumferential wall 110b is located inside the outer circumferential wall 110a and serves as a wall surface of the combustion chamber 100F. The inner circumferential wall 110b is a refractory brick, for example, which withstands a high temperature of about 1000° C., for example. A lower frame 113 is provided at a lower part of the combustion furnace 100. The lower frame 113 is a region without the inner circumferential wall 110b being the refractory brick, for example. A bottom frame 114 for closing the bottom of the combustion furnace 100 is provided at the bottom of the combustion furnace 100.

The combustion furnace 100 is in a shape with its longitudinal direction extending in one horizontal direction. A fuel supply port 111a for communicating the inside and the outside of the combustion furnace 100 is provided at one end of the wall 110 of the combustion furnace 100 in the longitudinal direction. A gas discharge port 112 is provided at the other end of the wall 110 of the combustion furnace 100 in the longitudinal direction. The wall 110 of the combustion furnace 100 has a part protruding outward below one end in the longitudinal direction. The fuel supply port 111a is located at the distal end of the protrusion described above. A fuel supply tunnel 111 extends inside the protrusion. The fuel supply tunnel 111 is in the shape gradually expanding upward from the fuel supply port 111a to the terminal 111b opposed to the combustion chamber 100F.

### Belt Conveyor

The belt conveyor 120 extends in the longitudinal direction of the combustion furnace 100, below the combustion furnace 100. The belt conveyor 120 is supported by the lower frame 113 and the bottom frame 114. The belt conveyor 120 has a starting point below the fuel supply port 111a. More precisely, the starting point of the belt conveyor 120 is right below the fuel supplier 130 connected to the fuel supply port 111a. The belt conveyor 120 extends from the point right below the fuel supplier 130 through the point right below the fuel supply port 111a, the fuel supply tunnel 111, and the inside of the combustion chamber 100F to a central portion of the combustion furnace 100 in the longitudinal direction. The belt of the belt conveyor 120 is obtained by combining link members made of cast iron. The top of the belt serves as a movable loader 120a for moving the solid fuel in the combustion chamber 100F.

The belt conveyor 120 is driven by a drive motor (not shown). The movable loader 120a of the belt conveyor 120 has a moving speed variable under the inverter control of the drive motor.

### Combustion Chamber

The combustion furnace 100 includes a plurality of partition walls 110d to 110g at predetermined intervals in the longitudinal direction of the combustion furnace 100. The plurality of partition walls 110d to 110g divide the combustion chamber 100F into a plurality of chambers. Specifically, the combustion chamber 100F is divided by a first partition wall 110d, a second partition wall 110e, a third partition wall 110f, and a fourth partition wall 110g in order from one end of the combustion furnace 100 in the longitudinal direction. The space between the one end of the wall 110 of the combustion furnace 100 in the longitudinal direction and the first partition wall 110d serves as a first combustion chamber 101F. The space between the first partition wall 110d and the second partition wall 110e serves as a second combustion chamber 102F. The space between the second partition wall 110e and the third partition wall 110f serves as a third combustion chamber 103F. The space between the third partition wall 110f and the fourth partition wall 110g serves as a fourth combustion chamber 104F. The space between the fourth partition wall 110g and the wall 110 at the other end of the combustion furnace 100 in the longitudinal direction serves as a fifth combustion chamber 105F. The first combustion chamber 101F communicates with the terminal 111b of the fuel supply tunnel 111, while the fifth combustion chamber 105F communicates with the gas discharge port 112.

The third combustion chamber 103F, the fourth combustion chamber 104F, and the fifth combustion chamber 105F are each in a size smaller than the first combustion chamber 101F and the second combustion chamber 102F. Only the first combustion chamber 101F out of the five combustion chambers 101F to 105F directly is opposed to the movable loader 120a of the belt conveyor 120 at the bottom thereof. Specifically, the terminal of the belt conveyor 120 extends to a point immediately below the second combustion chamber 102F. The second combustion chamber 102F and the belt conveyor 120 are however partitioned by a tunnel wall 110c. The starting point of the tunnel wall 110c is located right below the first partition wall 110d. The belt conveyor 120 enters a conveyor tunnel 106 defined by the tunnel wall 110c from the first combustion chamber 101F. From the point to the terminal, the belt conveyor 120 extends in the conveyor tunnel 106.

The solid fuel is burned on the movable loader 120a of the belt conveyor 120. The point where the solid fuel burns on the movable loader 120a is adjusted to overlap the location of the first combustion chamber 101F. The flame F caused by burning the solid fuel in the first combustion chamber 101F spreads upward in the first combustion chamber 101F. The generated exhaust gas is guided from the first combustion chamber 101F through the other combustion chambers 102F to 105F to the gas discharge port 112. As shown in FIG. 4, a first inspection port 115 is provided at a point of the wall 110 of the combustion furnace 100, which corresponds to the first combustion chamber 101F. By looking into the first inspection port 115, the conditions of the flame F generated in the first combustion chamber 101F can be checked. In addition, a worker can enter the first combustion chamber 101F from the first inspection port 115. A second inspection port 116 is provided at a point of the wall 110 of the combustion furnace 100, which corresponds to the second combustion chamber 102F.

The four partition walls 110d to 110g have openings 110d to 110go, respectively. The openings 110do to 110go are provided to guide the exhaust gas to the gas discharge port 112, while causing the exhaust gas to meander from one end to the other end of the combustion furnace 100 in the longitudinal direction. In FIG. 4, the first opening 110do of the first partition wall 110d is located at the right of the longitudinal center line O of the combustion furnace 100, when opposed to the gas discharge port 112 (see also FIG. 5). The second opening 110eo of the second partition wall 110e is located above the longitudinal center line O. The third opening 110fo of the third partition wall 110f is located below the longitudinal center line O. The fourth opening 110go of the fourth partition wall 110g is located above the longitudinal center line O. The gas discharge port 112 in the wall 110 at the other end of the combustion furnace 100 in the longitudinal direction is located below the longitudinal center line O.

As described above, the openings 110do to 110go and the gas discharge port 112 are alternately arranged above and below the longitudinal center line O in FIG. 4, which guides the exhaust gas from the first combustion chamber 101F along the arrow E in FIGS. 3 and 4.

### Fuel Supplier

As shown in FIGS. 3 and 4, the fuel supplier 130 is connected to the fuel supply port 111a. The upper end of the fuel supplier 130 is open. The solid fuel sent from the fermentation dryer 3 through the foreign matter sorter 4 is put into the upper opening and is then temporarily stored in the fuel supplier 130. As the solid fuel to be put in, refuse derived fuel (RDF), refuse paper & plastic fuel (RPF), and a fluff fuel at a stage prior to the formation of the RDF is also available. The fuel supplier 130 includes a thickness adjuster 131 for adjusting the thickness of the solid fuel to be placed on the movable loader 120a of the belt conveyor 120. The fuel supplier 130 continuously supplies the solid fuel whose thickness is adjusted by the thickness adjuster 131, from the fuel supply port 111a to the movable loader 120a of the belt conveyor 120.

Specifically, the thickness adjuster 131 of the fuel supplier 130 includes a gate 131a which is vertically movable to vary the vertical distance (t in FIG. 3) from the movable loader 120a of the belt conveyor 120, and a driver 131b which vertically moves the gate 131a along the arrow D in FIG. 3. The gate 131a is in the shape of a flat plate, for example, and has a linear lower end parallel to the movable loader 120a extending throughout the width of the movable loader 120a of the belt conveyor 120. The driver 131b is obtained using an electric motor, for example, to be able to finely change the vertical position of the gate 131a.

### Heat Exchanger

The heat exchanger 140 transfers the heat energy obtained by burning the solid fuel in the combustion chamber 100F to water. The heat exchanger 140 heats the water by means of the thermal energy generated by burning the solid fuel so as to generate high-temperature vapor. The vapor generated in this heat exchanger 140 is supplied as heating vapor through the vapor passage 70 in FIG. 1 to the vapor control device 92. The heating vapor supplied to the vapor control device 92 is supplied through the vapor passage 70 to the fermentation dryer 3 (e.g., the heating jacket 31 of the tank 30).

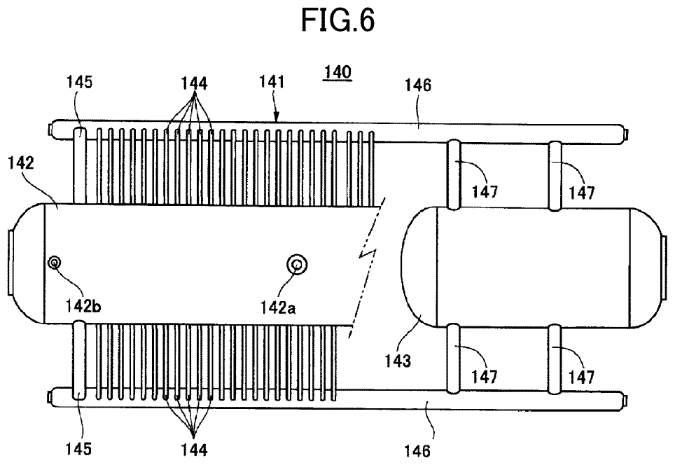

Specifically, the heat exchanger 140 includes a steam drum 142, a water drum 143, and water pipes 141. The steam drum 142 is located above the combustion furnace 100, has the horizontal direction as a longitudinal direction thereof, and has a bottom exposed to the combustion chamber 100F. The longitudinal direction of the steam drum 142 matches the longitudinal direction of the combustion furnace 100. The water drum 143 is provided below the steam drum 142 in the combustion furnace 100. The water pipes 141 each have one end connected to the steam drum 142 and the other end connected to the water drum 143. FIG. 6 is a plan view showing the connection relationship among the water pipes 141, the steam drum 142, and the water drum 143 of the heat exchanger 140 taken out of the boiler 7. In FIG. 6, the right of the steam drum 142 is located above the water drum 143, which is not shown. There are also water pipes 141 extending upward from the water drum 143 and connected to the steam drum 142, which are not shown. Now, a configuration of the heat exchanger 140 will be described in detail with reference to FIGS. 3 to 6.

In the heat exchanger 140, the water pipes 141 include a large number of first water pipes 144 extending in the vertical direction. Water flows through the inside of these first water pipes 144 and evaporates upon receipt of the heat energy generated by burning the solid fuel in the first combustion chamber 101F to the fifth combustion chamber 105F. As shown in FIG. 5, the first water pipes 144 are in the shape extending upward from the height of the water drum 143 along the wall 110 of the combustion furnace 100 in the transverse direction and bent from the ceiling of the combustion chamber 100F toward a central portion of the combustion furnace 100. The upper ends of the first water pipes 144 communicate with the steam drum 142. The large number of first water pipes 144 are arranged inside the outer circumferential wall 110a in the combustion chamber 100F. Most of the first water pipes 144 are exposed to the inside of the inner circumferential wall 110b, while some of the first water pipes 144 are embedded in the inner circumferential wall 110b.

The steam drum 142 has a circular cross section, receives the vapor obtained by evaporating the water flowing through the first water pipes 144, and extends along the longitudinal center line O of the combustion furnace 100. As shown in FIG. 3, the steam drum 142 extends across the five combustion chambers 101F to 105F divided from the combustion chamber 100F. The bottom of the steam drum 142 is exposed to all the combustion chambers 101F to 105F. The longitudinal direction of the steam drum 142 extends in the moving direction of the movable loader 120a of the belt conveyor 120. A vapor port 142a is open at a central portion of the steam drum 142, and the vapor collected from this vapor port 142a into the steam drum 142 is supplied to the vapor control device 92 through the vapor passage 70.

On the other hand, as shown in FIGS. 3 to 6, the water drum 143 has a circular cross section, stores the water to be supplied to each of the first water pipes 144, and extends along the longitudinal center line O of the combustion furnace 100 like the steam drum 142. The water drum 143 is located at a height substantially equal to the height of the belt conveyor 120. The water drum 143 and the belt conveyor 120 are separated by the tunnel wall 110c. The water drum 143 is located right below the third combustion chamber 103F, the fourth combustion chamber 104F, and the fifth combustion chamber 105F. The water drum 143 is supported by the lower frame 113 and the bottom frame 114.

Water is supplied to the water drum 143 from the outside. This water supply system can be described as follows. The steam drum 142 includes, at respective ends in the longitudinal direction, water supply ports 142b through which water is supplied into the steam drum 142. Two second water pipes 145 are connected to the lower end surface of this steam drum 142. These two second water pipes 145 pass through the inside of the outer circumferential wall 110a near the fuel supplier 130 (see FIG. 4).

Two third water pipes 146 are horizontally arranged around the water drum 143 at a height of a central portion of the water drum 143 in a direction (a horizontal direction in FIG. 4) extending in the longitudinal direction of the combustion furnace 100. To these two third water pipes 146, the lower ends of the two second water pipes 145 are connected, and the lower ends of the large number of first water pipes 144 arranged along the inner wall of the combustion chamber 100F (i.e., the five combustion chambers 101F to 105F) are exposed. In addition, four fourth water pipes 147 (see FIG. 6) are connected to the two third water pipes 146. These fourth water pipes 147 are each connected to the water drum 143.

The water supplied from the water supply port 142b into the steam drum 142 is then supplied through the second water pipes 145, the third water pipes 146, and the fourth water pipes 147 to the water drum 143 and is stored temporarily. The water stored in the water drum 143 flows from the third water pipes 146 into the bottoms of the large number of first water pipes 144, flows upward in these first water pipes 144, and becomes vapor due to the transferred heat energy caused by burning the solid fuel in the combustion chamber 100F (i.e., the five combustion chambers 101F to 105F) while flowing upward. This vapor is collected in the steam drum 142 and supplied from the vapor port 142a through the vapor passage 70 to the vapor control device 92.

The water pipes 141 of the heat exchanger 140 include fifth water pipes 148 in addition to the first water pipes 144, the second water pipes 145, the third water pipes 146, and the fourth water pipes 147 described above. As shown in FIG. 4, the fifth water pipes 148 extend upward from the water drum 143 and are then connected to the steam drum 142. A large number of these fifth water pipes 148 are exposed in the third combustion chamber 103F, the fourth combustion chamber 104F, and the fifth combustion chamber 105F. The exhaust gas flowing in the combustion chamber 100F toward the gas discharge port 112 while meandering can come into contact with the fifth water pipes 148 efficiently. The fifth water pipes 148 are arranged at predetermined intervals in parallel with the transverse direction of the combustion furnace 100. In the third combustion chamber 103F, the fourth combustion chamber 104F, and the fifth combustion chamber 105F, the exhaust gas mainly flows in the transverse direction of the combustion furnace 100. This arrangement makes it difficult for ash to adhere to the large number of fifth water pipes 148. For example, if the fifth water pipes 148 are arranged in a staggered manner, ash adheres easily.

### Forced Draft Fan and Air Inflow Damper

As shown in FIG. 3, the bottom frame 114 of the combustion furnace 100 has, in a wall thereof at a height lower than the movable loader 120a of the belt conveyor 120, a combustion air inlet 114a for introducing combustion air from the outside into the combustion chamber 100F. As shown in FIG. 4, a forced draft fan 160 is connected to this combustion air inlet 114a via an air intake duct 161. The forced draft fan 160 causes the combustion air to pass upward from below the movable loader 120a of the belt conveyor 120 so as to supply the combustion air to the solid fuel on the movable loader 120a. Since the movable loader 120a of the belt conveyor 120 is obtained by combining link members made of cast iron, there are gaps between adjacent link members, which allows the combustion air to pass upward from below the movable loader 120a. The gaps between the adjacent link members of the movable loader 120a are set to be sufficiently small no to allow the solid fuel on the movable loader 120a to fall down through the gaps.

As shown in FIG. 3, the lower frame 113 of the combustion furnace 100 has, in a wall thereof, air inflow dampers 113a for adjusting the amount of air to be introduced into the vicinity of the belt conveyor 120. These air inflow dampers 113a extend in the moving direction of the movable loader 120a of the belt conveyor 120. Each air inflow damper 113a is interposed between the movable loader 120a of the belt conveyor 120 and the combustion air inlet 114a in the vertical direction, and can allow or prohibit the combustion air supplied from the combustion air inlet 114a to the movable loader 120a by the driving of the forced draft fan 160 to pass.

The opening degree of each air inflow damper 113a is adjustable within a range from 0% to 100% manually or automatically. At an opening degree of 0%, the combustion air is not supplied to the solid fuel on the movable loader 120a near the point right above the air inflow damper 113a. The solid fuel remains unburned and is vaporized. At an opening degree of 100%, a large amount of combustion air is supplied to the solid fuel on the movable loader 120a near the point right above the air inflow damper 113a. The solid fuel can be largely burned. By adjusting the opening degree of each of the air inflow dampers 113a arranged in the moving direction of the movable loader 120a of the belt conveyor 120, the point of burning the solid fuel in the whole movable loader 120a of the belt conveyor 120 can be adjusted.

### Ash Discharge Conveyor

The terminal of the belt conveyor 120 is located at the inner end of the conveyor tunnel 106 in the combustion furnace 100. The bottom frame 114 has an ash outlet 114b in a wall thereof below this terminal of the belt conveyor 120. As shown in FIG. 4, an ash discharge conveyor 170 is inserted through this ash outlet 114b. This ash discharge conveyor 170 discharges the ash of the solid fuel remaining on the movable loader 120a of the belt conveyor 120 to the outside of the combustion furnace 100. On the movable loader 120a, the solid fuel is burned mainly at a point corresponding to the first combustion chamber 101F to cause a flame F, and a new solid fuel is constantly supplied from the fuel supply port 111a to the point at which the flame F occurs due to the continuously moving movable loader 120a. From the point at which the flame F occurs to the terminal of the belt conveyor 120, the ash obtained by burning the solid fuel always moves toward the terminal of the belt conveyor 120. Even if continuously moved to the terminal of the belt conveyor 120 by continuously driving the belt conveyor 120, the ash can be discharged outside the combustion furnace 100 by the ash discharge conveyor 170.

### Configuration of Discharging Exhaust Gas

As shown in FIGS. 1, 3, and 4, a discharge passage 150 is connected to the gas discharge port 112 of the combustion furnace 100. An economizer 151 is disposed in this discharge passage 150. The economizer 151 raises the temperature of the drain water supplied from a drain collecting tank 153 to 100° C., for example, by applying the thermal energy of the exhaust gas discharged from the gas discharge port 112 in advance, and supplies the drain water to the steam drum 142. In addition, a dust collector 152 and a water scrubber 154 are provided in the discharge passage 150 at a downstream side of the economizer 151. The dust collector 152 and the water scrubber 154 remove fine particles in the exhaust gas which is then discharged into the atmosphere.

In addition to and behind the dust collector 152 and the water scrubber 154 in the discharge passage 150, an air induction fan 155 is provided. This air induction fan 155 adjusts the pressure in the combustion furnace 100 to be negative, in cooperation with the forced draft fan 160. The pressure in the furnace is made negative by the air induction fan 155 and the forced draft fan 160 not to cause the flame F to flow outside and so as to control the conditions of the flame F. In an emergency, the forced draft fan 160 may stop and only the air induction fan 155 may operate.

### Vapor Control Device

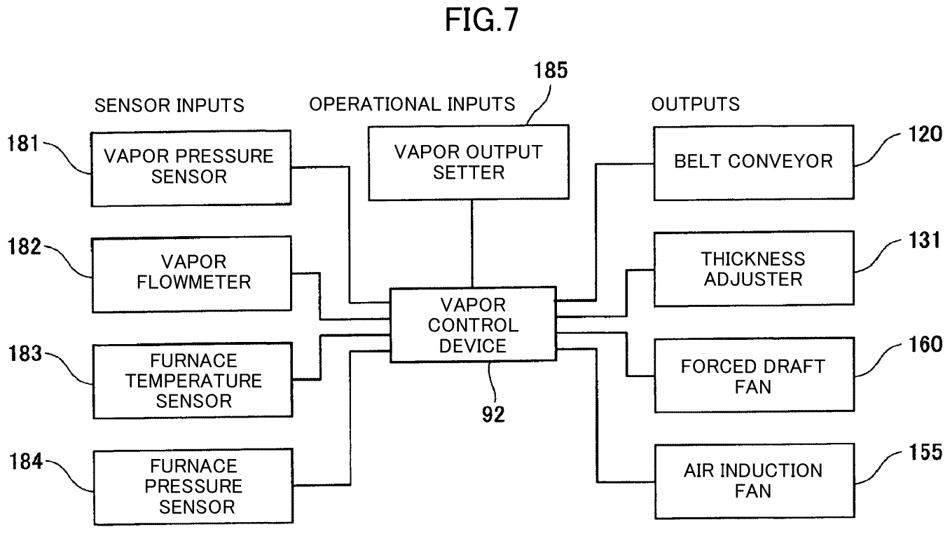

FIG. 7 is a block diagram showing a configuration for controlling the vapor output from the boiler 7. As shown in FIGS. 1 and 7, the vapor control device 92 controls the supply of a part of the vapor, which has been supplied through the vapor passage 70, through the vapor passage 70 to the fermentation dryer 3 and the heating of the heating jacket 31 of the circumferential wall of the tank 30 of the fermentation dryer 3. The vapor control device 92 causes another part of the supplied vapor to be supplied to the vapor generator 91.

The vapor control device 92 is connected to a vapor pressure sensor 181, a vapor flowmeter 182, a furnace temperature sensor 183, a vapor output setter 185, the belt conveyor 120, the thickness adjuster 131, the forced draft fan 160, and the air induction fan 155. The vapor pressure sensor 181 and the vapor flowmeter 182 are provided, for example, in the vapor passage 70 between the vapor port 142a of the steam drum 142 and the vapor control device 92. The vapor pressure sensor 181 measures the pressure of the vapor generated in the steam drum 142. The vapor flowmeter 182 also measures the flow rate of the vapor passing through the vapor passage 70. The furnace temperature sensor 183 is attached at a point at which the temperature in the combustion chamber 100F is measurable. A furnace pressure sensor 184 is attached to attached at a point at which the pressure of the combustion chamber 100F is measurable. The vapor control device 92 monitors the pressure and flow rate of the vapor supplied through the vapor port 142a of the steam drum 142, using the vapor pressure sensor 181 and the vapor flowmeter 182. The vapor control device 92 monitors the temperature and pressure in the combustion chamber 100F, using the furnace temperature sensor 183 and the furnace pressure sensor 184.

The vapor output setter 185 is provided to set the output of vapor to be supplied to the vapor generator 91 including a vapor turbine generator, for example. Once a worker operates the vapor output setter 185 to set the vapor output, the vapor control device 92 controls the operations of the belt conveyor 120, the thickness adjuster 131, the forced draft fan 160, and the air induction fan 155, based on the signals output from the vapor pressure sensor 181, the vapor flowmeter 182, the furnace temperature sensor 183, and the furnace pressure sensor 184, so that the set vapor output is available.

Specifically, the vapor control device 92 controls the drive motor of the belt conveyor 120 to adjust the moving speed of the movable loader 120a, and controls the driver 131b of the thickness adjuster 131 to adjust the vertical position of the gate 131a, thereby adjusting the amount of the solid fuel to be supplied to the first combustion chamber 101F. The vapor control device 92 controls the air flow rate of the forced draft fan 160 and the air induction fan 155 to adjust the pressure in the combustion chamber 100F to be negative.

The vapor control device 92 can also vary the vapor output in accordance with the variation in the amount of vapor to be used in the vapor generator 91. In this case, the vapor pressure sensor 181 and the vapor flowmeter 182 may be provided at points at which the pressure and the flow rate of the vapor to be used in the vapor generator 91 are measurable, and the feedback control may be performed.

As described above, the boiler 7 according to this embodiment includes: a combustion furnace 100 having a combustion chamber 100F (i.e., five combustion chambers 101F to 105F) therein; a heat exchanger 140 configured to transfer, to water, thermal energy obtained by burning a solid fuel in the combustion chamber 100F; a belt conveyor 120 including a movable loader 120a, disposed on a bottom of the combustion chamber 100F, and configured to move the solid fuel on the movable loader 120a in the combustion chamber 100F; and a fuel supplier 130 connected to a fuel supply port 111a that communicates an inside and an outside of the combustion furnace 100. The belt conveyor 120 has a starting point below the fuel supply port 111a. The fuel supplier 130 includes a thickness adjuster 131 for adjusting the thickness of the solid fuel to be placed on the movable loader 120a of the belt conveyor 120.

According to the configuration described above, the solid fuel can be directly put into the combustion furnace 100 through the fuel supply port 111a, and can be moved by the belt conveyor 120 to an appropriate point in the combustion chamber 100F where thermal energy is easily transmitted to the water of the heat exchanger 140. The solid fuel is gasified and ignited in the combustion chamber 100F, which can cause a flame on the movable loader 120a of the belt conveyor 120. In addition, the thickness of the solid fuel on the movable loader 120a of the belt conveyor 120 is adjusted by the thickness adjuster 131 of the fuel supplier 130, which can adjust the amount of the solid fuel to be gasified. Accordingly, the flame can spread largely in the horizontal direction and the vertical direction in the combustion chamber 100F and the heat exchanger 140 can thus be heated with strong heating power over a wide area.

Since the location and area of the solid fuel in the combustion chamber 100F and the amount of the solid fuel can be adjusted easily by adjusting the speed of the belt conveyor 120 and the thickness using the thickness adjuster 131, the amount of thermal energy to be transferred to the water of the heat exchanger 140 can be adjusted easily. Accordingly, the output of the vapor to be generated by the heat exchanger 140 can be adjusted easily. The vapor output can thus accord to even a variation in the amount of vapor to be used in the vapor generator 91 utilizing the vapor of the boiler 7. As a result, an energy-saving boiler 7 can be provided.

In this embodiment, the thickness adjuster 131 of the fuel supplier 130 includes a gate 131a which is vertically movable to vary the vertical distance from the movable loader 120a of the belt conveyor 120, and a driver 131b which vertically moves the gate 131a.

According to the configuration described above, the thickness of the solid fuel on the movable loader 120a of the belt conveyor 120 can be easily adjusted with a simple configuration. This can easily adjust the output by changing the thickness in accordance with the characteristics of the solid fuel to be used, and easily shut off the fuel supply by moving the gate 131a in an emergency so as to eliminate the gap between the lower end of the gate 131a and the movable loader 120a.

In this embodiment, the heat exchanger 140 includes: a steam drum 142 disposed above the combustion furnace 100, having the horizontal direction as a longitudinal direction thereof, and having a bottom exposed to the combustion chamber 100F; a water drum 143 below the steam drum 142 in the combustion furnace 100; and water pipes 141 each having one end connected to the steam drum 142 and the other end connected to the water drum 143. The belt conveyor 120 is disposed with the moving direction of the movable loader 120a matching the longitudinal direction of the steam drum 142.

According to the configuration described above, the solid fuel on the movable loader 120a of the belt conveyor 120 can be located right below the part of the steam drum 142 exposed to the combustion chamber 100F over a wide area. Accordingly, the hot air of the flame generated by gasifying and igniting the solid fuel can be widely and directly applied to the steam drum 142. This can thus efficiently transmit the thermal energy to the heat exchanger 140 including the steam drum 142, and accelerate the reaction of vapor output generation from the start of driving of the boiler 7.

In this embodiment, the first water pipes 144 and the fifth water pipes 148 extend in the vertical direction in the combustion chamber 100F. The combustion furnace 100 includes the fuel supply port 111a in a wall at one end of the steam drum 142 in the longitudinal direction and a gas discharge port 112 in a wall at the other end of the steam drum 142 in the longitudinal direction. The combustion furnace 100 includes a plurality of partition walls 110d to 110g at predetermined intervals in the longitudinal direction of the steam drum 142 which are divided from the combustion chamber 100F. These partition walls 110d to 110g include openings 110do to 100go, respectively, for brining exhaust gas into contact with the first water pipes 144 and the fifth water pipes 148 in the combustion chamber 100F, while allowing the exhaust gas to meander from the one end toward the other end of the steam drum 142.

The configuration described above can increase the period of time when the exhaust gas in the combustion chamber 100F stays and applies the flame and the exhaust gas to the first water pipes 144 and the fifth water pipes 148 efficiently. Accordingly, the thermal energy can be efficiently transferred to the heat exchanger 140 including the water pipes 141.

In this embodiment, the bottom frame 114 of the combustion furnace 100 has, in a wall thereof at a height lower than the movable loader 120a of the belt conveyor 120, a combustion air inlet 114a for introducing combustion air from the outside into the combustion chamber 100F. A forced draft fan 160 is connected to this combustion air inlet 114a via an air intake duct 161.

According to the configuration described above, the combustion air sent from below the movable loader 120a of the belt conveyor 120 is sent upward from below the solid fuel on the movable loader 120a, which can promote the gasification of the solid fuel and spread, upward from the movable loader 120a, the flame generated by igniting the gasified gas. Accordingly, the thermal energy can be efficiently transferred to the heat exchanger 140 over a wide area.

In this embodiment, the lower frame 113 of the combustion furnace 100 has, in a wall thereof in the moving direction of the movable loader 120a of the belt conveyor 120, air inflow dampers 113a for adjusting the amount of air to be introduced into the vicinity of the belt conveyor 120.

According to the configuration described above, when the solid fuel on the movable loader 120a spreads in the moving direction of the movable loader 120a as the belt conveyor 120 is driven, the amount of the solid fuel to be gasified and ignited at each point of the belt conveyor can be adjusted by adjusting the amount of the air to be introduced by each air inflow damper 113a. Accordingly, the magnitude and the point of the flame generated on the movable loader 120a can be adjusted easily. The output of the vapor to be generated in the heat exchanger 140 can thus be adjusted easily. In an emergency, the solid fuel can remain unburned and is vaporized by setting the opening degrees of all the air inflow dampers 113a to zero.

In this embodiment, an ash discharge conveyor 170 for discharging ash of the solid fuel remaining on the movable loader 120a to the outside of the combustion furnace 100 is connected to a wall of the bottom frame 114 of the combustion furnace 100 at a point below the terminal of the belt conveyor 120.

According to the configuration described above, even if the ash obtained by igniting and burning the solid fuel on the movable loader 120a is continuously moved to the terminal of the belt conveyor 120 by continuously driving the belt conveyor 120, the ash can be discharged outside the combustion furnace 100 by the ash discharge conveyor 170. Accordingly, the movable loader 120a of the belt conveyor 120 is not completely buried in the ash. The solid fuel on the movable loader 120a can thus be efficiently burned at all times.

In this embodiment, the organic waste processor includes the boiler 7 and the fermentation dryer 3. The boiler 7 supplies the dried matter obtained by the fermentation dryer 3 as the solid fuel to the combustion chamber 100F of the combustion furnace 100. This configuration eliminates the need to process the waste of the dried matter obtained by the fermentation dryer 3. In addition, the dried matter can be incinerated efficiently and immediately.

The disclosed embodiment is illustrative in all respects and do not serve as a basis for restrictive interpretation. The scope of the present invention is not interpreted only by the above-described embodiment, but is defined based on the description of the claims. The scope of the present invention includes all modifications within the meaning and scope equivalent to the scope of the claims.

### INDUSTRIAL APPLICABILITY

The present invention is applicable to a boiler for saving energy and an organic waste processor including the boiler.

DESCRIPTION OF REFERENCE CHARACTERS

| | |
|---|---|
| 1 | Processor |
| 3 | Fermentation Dryer |
| 7 | Boiler |
| 100 | Combustion Furnace |
| 100F | Combustion Chamber |
| 101F | First Combustion Chamber |
| 102F | Second Combustion Chamber |
| 103F | Third Combustion Chamber |
| 104F | Fourth Combustion Chamber |
| 105F | Fifth Combustion Chamber |
| 110 | Wall |
| 110d | First Partition Wall |
| 110do | First Opening |
| 110e | Second Partition Wall |
| 110eo | Second Opening |
| 110f | Third Partition Wall |
| 110fo | Third Opening |
| 110g | Fourth Partition Wall |
| 110go | Fourth Opening |
| 111a | Fuel Supply Port |
| 113a | Air Inflow Damper |
| 114a | Combustion Air Inlet |
| 120 | Belt Conveyor |
| 120a | Movable Loader |
| 130 | Fuel Supplier |
| 131 | Thickness Adjuster |
| 131a | Gate |
| 131b | Driver |
| 140 | Heat Exchanger |
| 141 | Water Pipe |
| 142 | Steam Drum |
| 143 | Water Drum |
| 144 | First Water Pipe |
| 145 | Second Water Pipe |
| 146 | Third Water Pipe |
| 147 | Fourth Water Pipe |
| 148 | Fifth Water Pipe |
| 160 | Forced Draft Fan |
| 161 | Air Intake Duct |
| 170 | Ash Discharge Conveyor |

1. A boiler comprising:
a combustion furnace having a combustion chamber therein;
a heat exchanger configured to transfer, to water, thermal energy obtained by burning a solid fuel in the combustion chamber;
a belt conveyor including a movable loader, disposed on a bottom of the combustion chamber, and configured to move the solid fuel on the movable loader in the combustion chamber; and
a fuel supplier connected to a fuel supply port that communicates an inside and an outside of the combustion furnace,
the belt conveyor having a starting point below the fuel supply port,
the fuel supplier including a thickness adjuster that adjusts a thickness of the solid fuel on the movable loader of the belt conveyor.

2. The boiler of claim 1, wherein
the thickness adjuster of the fuel supplier includes a gate movable vertically so as to change a vertical distance from the movable loader of the belt conveyor, and a driver configured to move the gate vertically.

3. The boiler of claim 1, wherein
the heat exchanger includes:
a steam drum disposed above the combustion furnace, having a horizontal direction as a longitudinal direction thereof, and having a bottom exposed to the combustion chamber;
a water drum below the steam drum in the combustion furnace; and
water pipes each having one end connected to the steam drum and the other end connected to the water drum, wherein
the belt conveyor is disposed with a moving direction of the movable loader matching the longitudinal direction of the steam drum.

4. The boiler of claim 3, wherein
at least some of the water pipes extend in the vertical direction in the combustion chamber,
the combustion furnace includes the fuel supply port in a wall at one end of the steam drum in the longitudinal direction and a gas discharge port in a wall at the other end of the steam drum in the longitudinal direction,
the combustion furnace further includes a plurality of partition walls at predetermined intervals in the longitudinal direction of the steam drum so as to partition the combustion chamber, and
each of the plurality of partition walls includes an opening for brining exhaust gas into contact with the water pipe in the combustion chamber, while allowing the exhaust gas to meander from the one end toward the other end of the steam drum.

5. The boiler of claim 4, wherein
the combustion furnace has a wall having a combustion air inlet for introducing combustion air from the outside into the combustion chamber at a height below the movable loader of the belt conveyor, and
a forced draft fan is connected to the combustion air inlet via an air intake duct.

6. The boiler of claim 5, wherein
the combustion furnace has a wall having a plurality of air inflow dampers for adjusting an amount of air to be introduced near the belt conveyor, in the moving direction of the movable loader.

7. The boiler of claim 6, wherein
an ash discharge conveyor for discharging ash of the solid fuel remaining on the movable loader to the outside of the combustion furnace is connected to a wall of the combustion furnace, below a terminal of the belt conveyor.

8. An organic waste processor comprising:
the boiler of claim 1; and
a fermentation dryer contain a processing target containing an organic waste in a sealed container, and configured to stir the processing target, while heating the processing target to a predetermined temperature range under a reduced pressure, and ferments an organic matter using microorganisms to decompose an odorous component and obtain a dried matter with a reduced volume, wherein
dried matter provided by the fermentation dryer is supplied as the solid fuel to the combustion chamber of the combustion furnace of the boiler.
